(19) United States
(12) Patent Application Publication
(10) Pub. No.: US 2026/0212044 A1
(43) Pub. Date: Jul. 23, 2026

(54) ROBUSTNESS AGAINST DEANONYMIZATION

(71) Applicant: QUALCOMM Incorporated, San Diego, CA (US)

(72) Inventors: Oguzhan BASER, Somerset, NJ (US); Kapil GULATI, Belle Mead, NJ (US); Himaja KESAVAREDDIGARI, Bridgewater, NJ (US); Hong CHENG, Basking Ridge, NJ (US); Qing LI, Princeton Junction, NJ (US); Junyi LI, Greentown, PA (US); Tien Viet NGUYEN, Bridgewater, NJ (US)

(21) Appl. No.: 19/031,108

(22) Filed: Jan. 17, 2025

(51) Int. Cl. G06F 21/62

(52) U.S. Cl. CPC G06F 21/6254

(57) ABSTRACT

Systems and techniques are described herein for data privacy. For instance, a process can include receiving, from a plurality of applications, anonymization information indicating types of anonymized data collected by the plurality of applications; determining a risk level for data deanonymization for the anonymized data collected by the plurality of applications based on shared types of data collected by the plurality of applications; and adjusting, based on the determined risk level, a setting of an application of the plurality of applications.

### FIELD

The present disclosure generally relates to data deanonymization. For example, aspects of the present disclosure are related to systems and techniques for robustness against deanonymization.

### BACKGROUND

Devices may include information that users may consider sensitive and/or private. One technique for balancing user privacy while still making analytics information available is data anonymization. Data anonymization can be used to remove and/or change personally identifiable information (PII) from a dataset to prevent being able to link the data being collected to a specific person or small group of people. Examples of data anonymization may include blurring faces, landmarks, etc., changing specific addresses to zip codes or address ranges, removing or encrypting specific identifiers, etc.

In some cases, advanced devices (e.g., digital car platforms, augment reality (AR), virtual reality (VR), extended reality (XR) devices, etc.) may include multiple applications capable of collecting rich data, such as multi-modal sensor information, location information, communications, etc. In such an environment, ad-hoc, per application-based anonymization and/or anonymity configurations may not be sufficient.

### SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary presents certain concepts relating to one or more aspects relating to the mechanisms disclosed herein in a simplified form to precede the detailed description presented below.

Disclosed are systems, apparatuses, methods and computer-readable media for data privacy. In one illustrative example, an apparatus for data privacy is provided. The apparatus includes a memory and a processor coupled to the memory. The processor is configured to: receive, from a plurality of applications, anonymization information indicating types of anonymized data collected by the plurality of applications; determine a risk level for data deanonymization for the anonymized data collected by the plurality of applications based on shared types of data collected by the plurality of applications; and adjust, based on the determined risk level, a setting of an application of the plurality of applications.

In another example, a method for data privacy is provided. The method includes: receiving, from a plurality of applications, anonymization information indicating types of anonymized data collected by the plurality of applications; determining a risk level for data deanonymization for the anonymized data collected by the plurality of applications based on shared types of data collected by the plurality of applications; and adjusting, based on the determined risk level, a setting of an application of the plurality of applications.

As another example, a non-transitory computer-readable medium having stored thereon instructions is provided. The instructions, when executed by at least one processor, cause the at least one processor to: receive, from a plurality of applications, anonymization information indicating types of anonymized data collected by the plurality of applications; determine a risk level for data deanonymization for the anonymized data collected by the plurality of applications based on shared types of data collected by the plurality of applications; and adjust, based on the determined risk level, a setting of an application of the plurality of applications.

In another example, an apparatus for data privacy is provided. The apparatus includes: means for receiving, from a plurality of applications, anonymization information indicating types of anonymized data collected by the plurality of applications; means for determining a risk level for data deanonymization for the anonymized data collected by the plurality of applications based on shared types of data collected by the plurality of applications; and means for adjusting, based on the determined risk level, a setting of an application of the plurality of applications.

In some aspects, one or more of the apparatuses described herein comprises a mobile device (e.g., a mobile telephone or so-called “smart phone”, a tablet computer, or other type of mobile device), a wearable device, an extended reality device (e.g., a virtual reality (VR) device, an augmented reality (AR) device, or a mixed reality (MR) device), a personal computer, a laptop computer, a video server, a television (e.g., a network-connected television), a vehicle (or a computing device of a vehicle), or other device. In some aspects, the apparatus(es) include at least one camera for capturing one or more images or video frames. For example, the apparatus(es) can include a camera (e.g., an RGB camera) or multiple cameras for capturing one or more images and/or one or more videos including video frames. In some aspects, the apparatus(es) can include a display for displaying one or more images, videos, notifications, or other displayable data. In some aspects, the apparatus(es) can include a transmitter configured to transmit one or more video frame and/or syntax data over a transmission medium to at least one device.

In some aspects, the processor includes a neural processing unit (NPU), a central processing unit (CPU), a graphics processing unit (GPU), or other processing device or component.

This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

The foregoing, together with other features and embodiments, will become more apparent upon referring to the following specification, claims, and accompanying drawings.

### BRIEF DESCRIPTION OF THE DRAWINGS

Illustrative embodiments of the present application are described in detail below with reference to the following figures:

FIG. 1 illustrates an example implementation of a system-on-a-chip (SOC), in accordance with some examples;

FIG. 2 is a block diagram illustrating an architecture of a device including an on-device anonymity layer, in accordance with aspects of the present disclosure;

FIG. 3 is a diagram illustrating an architecture of an on-device anonymity layer, in accordance with aspects of the present disclosure;

FIG. 4 is a flow diagram illustrating a process for data privacy, in accordance with aspects of the present disclosure; and

FIG. 5 illustrates an example computing device architecture of an example computing device which can implement the various techniques described herein.

### DETAILED DESCRIPTION

Certain aspects and embodiments of this disclosure are provided below. Some of these aspects and embodiments may be applied independently and some of them may be applied in combination as would be apparent to those of skill in the art. In the following description, for the purposes of explanation, specific details are set forth in order to provide a thorough understanding of embodiments of the application. However, it will be apparent that various embodiments may be practiced without these specific details. The figures and description are not intended to be restrictive.

The ensuing description provides example embodiments only, and is not intended to limit the scope, applicability, or configuration of the disclosure. Rather, the ensuing description of the example embodiments will provide those skilled in the art with an enabling description for implementing an example embodiment. It should be understood that various changes may be made in the function and arrangement of elements without departing from the spirit and scope of the application as set forth in the appended claims.

Applications executing on a device can access and/or generate data that users may consider private, such as demographical data, address and location history, call/message records, etc. In some cases, analysis of such data may be helpful, for example, to application developers to improve applications. However, to preserve the privacy of users, data may be anonymized before being provided to other parties (e.g., application developers, researchers, etc.).

Generally, privacy and/or anonymity for devices is handled by applications executing on the devices. For example, a first application may anonymize data collected by the first application, while a second application may not anonymize data collected by the second application. In some cases, this disparity across applications can be leveraged by third parties to deanonymize anonymized information. Anonymized data may be data used, obtained, captured, and/or generated by applications which has been processed to remove and/or change information that may be considered private such that the information cannot be linked back to a specific person. As an example of deanonymizing anonymized information, data from the second application may be cross-referenced and/or correlated with anonymized data from the first application to deanonymize the anonymized data. A Further, even where data is anonymized by the applications, certain information may be inferred from the dataset of one application and this information may be used to cross reference and/or correlated with anonymized data from another application to narrow down or deanonymize data from another application. Modern devices, and the applications executing on these devices, may have access to a variety of rich datasets and ad-hoc, per application-based anonymization and/or anonymity configurations may not be sufficient.

Systems, apparatuses, electronic devices, methods (also referred to as processes), and computer-readable media (collectively referred to herein as “systems and techniques”) are described herein for providing robustness against deanonymization of data. For example, a device anonymity layer may be added to interface with applications and monitor whether an expected amount of anonymity for a given individual user's particular data sharing is being provided. In some cases, the anonymity layer may receive a set of user anonymity preferences for user data. The anonymity layer may receive anonymization information from applications of a set of applications. The anonymization information for an application may indicate the types of anonymized data collected/produced by the application. The types of anonymized data may be an indication of a type of information that has been anonymized, such as photos, videos, location information, demographic data, name, address, etc. In some cases, the types of anonymized data collected may be provided in a data structure which includes information about a data element collected, a format of the data element collected, and quality of the data collected. In some cases, one or more sources of public information about the user may also be received. Example sources of public information may include tax records, court filings, publicly accessible databases, and the like. The anonymity layer may determine a risk level for deanonymization (e.g., deanonymization risk level) for the anonymized data based on shared types of data collected by multiple applications and the user anonymity preferences.

Based on the determined risk level for data anonymization, privacy/anonymity settings of the applications may be adjusted. In some cases, adjusting the privacy/anonymity settings of an application may include suggesting a change to an application that can change a data element of the anonymization information of associated with the application. In some cases, prohibiting the collection and/or storage of one or more types of data elements by an application if the data elements are not necessary for the efficient operation of the application. In some cases, adjusting the privacy/anonymity settings of an application may include prohibiting execution of a first application concurrently with a second application. Prohibiting concurrent execution of applications may limit an amount of information that may be cross-referenced and/or correlated across the applications. In some cases, adjusting the privacy/anonymity settings of an application may include prohibiting execution of a first application based on a history of execution for a second application. In some cases, limiting concurrent operation may be insufficient. For example, where location information is collected by two applications, allowing back-to-back operation of the two applications may still allow for cross referencing and/or correlating the location information. In such cases, there may be limits to when an application can execute, such as after a certain amount of time has elapsed, location changes, etc.

Various aspects of the present disclosure will be described with respect to the figures.

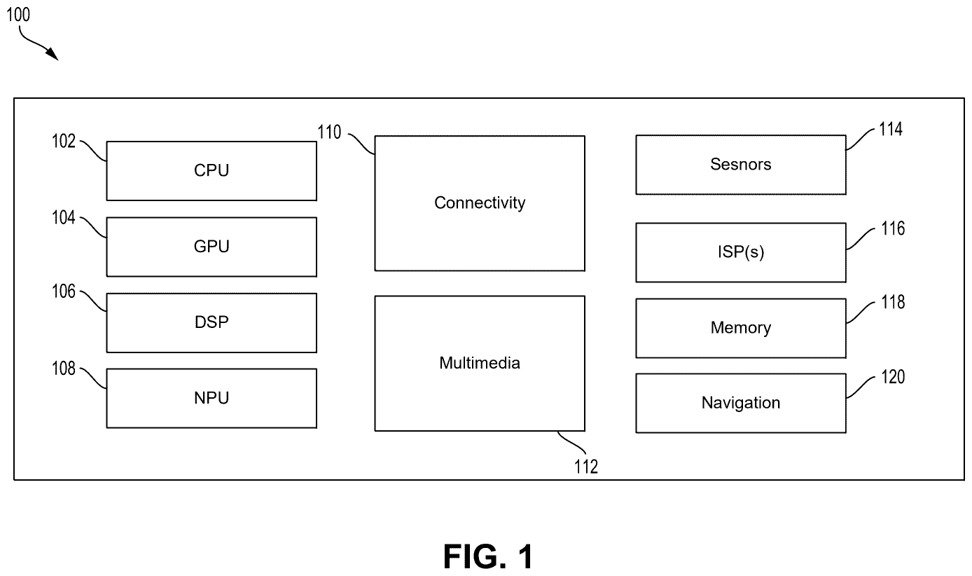

FIG. 1 illustrates an example implementation of a system-on-a-chip (SOC) 100, which may include a central processing unit (CPU) 102 or a multi-core CPU, configured to perform one or more of the functions described herein. Parameters or variables (e.g., neural signals and synaptic weights), system parameters associated with a computational device (e.g., neural network with weights), delays, frequency bin information, task information, among other information may be stored in a memory block associated with a neural processing unit (NPU) 108, in a memory block associated with a CPU 102, in a memory block associated with a graphics processing unit (GPU) 104, in a memory block associated with a digital signal processor (DSP) 106, in a memory block 118, and/or may be distributed across multiple blocks. Instructions executed at the CPU 102 may be loaded from a program memory associated with the CPU 102 or may be loaded from a memory block 118.

The SOC 100 may also include additional processing blocks tailored to specific functions, such as a GPU 104, a DSP 106, a connectivity block 110, which may include fifth generation (5G) connectivity, fourth generation long term evolution (4G LTE) connectivity, Wi-Fi connectivity, USB connectivity, Bluetooth connectivity, and the like, and a multimedia processor 112 that may, for example, detect and recognize gestures. In one implementation, the NPU is implemented in the CPU 102, DSP 106, and/or GPU 104. The SOC 100 may also include a sensor processor 114, image signal processors (ISPs) 116, and/or navigation module 120, which may include a global positioning system.

The SOC 100 may be based on an ARM instruction set. SOC 100 and/or components thereof may be configured to perform segmentation mask extrapolation. For example, the CPU 102, DSP 106, and/or GPU 104 may be configured to perform object detection using a visual language model via latent feature adaptation with synthetic data.

Applications may collect and/or generate a large amount of data. For example, a digital cockpit application for an autonomous/semi-autonomous vehicle may collect and/or generate location information, camera images, speed information, etc. In some cases, to help maintain privacy of users, applications may anonymize certain data, such as personally identifiable information (PII), for example, by replacing certain data with identifiers, swapping data, blurring faces, etc. In some cases, specific (e.g., individual) applications on a device may include application specific privacy and/or anonymity configurations that may be adjusted by a user on a per application basis. While such techniques may be effective for specific applications, anonymized data may be de-anonymized by cross-referencing and/or correlating anonymized data across multiple applications (e.g., multiple applications executing concurrently on the device) and/or cross-referencing/correlating the anonymized data with publicly available information to re-identify at least some of the anonymized data and/or compromise the personal identity of a data source (e.g., person associated with the anonymized data). For example, a navigation application may anonymize location information and a dash camera application may anonymize faces and street signs captured on a trip, but an attacker may be able to deanonymize the location information of the navigation application by performing location recognition on the images recorded by the dash camera application. In some cases, an on-device anonymity layer may be added to provide increased robustness against data deanonymization.

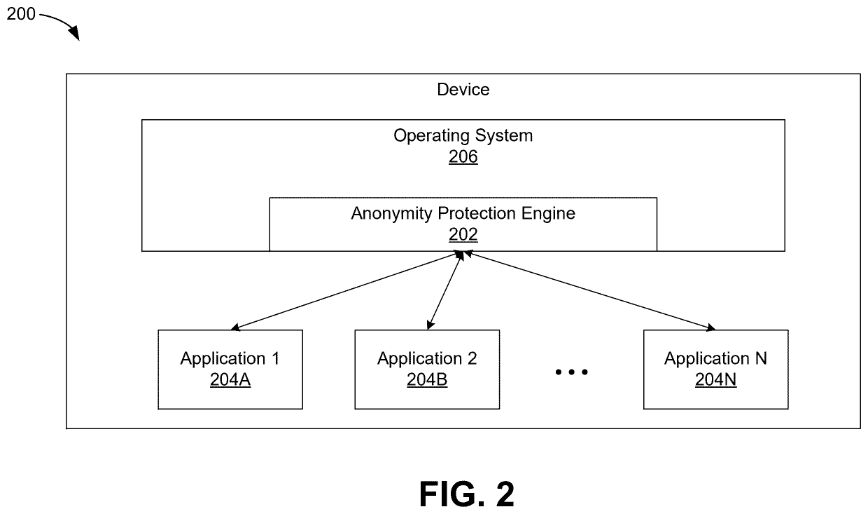

FIG. 2 is a block diagram illustrating an architecture of a device 200 including an on-device anonymity layer, in accordance with aspects of the present disclosure. In some cases, the on-device anonymity layer 202 may be added. The anonymity layer 202 may interface with and monitor applications 204A, 204B, . . . 204N (collectively applications 204) on the device 200 to determine whether a desired amount of anonymity is being maintained across the applications 204 on the device 200 and to adjust operations of the applications to help maintain the desired amount of anonymity. In some cases, the on-device anonymity layer 202 may be used to adjust operations of how the applications 204 executing on the device 200 operate to help reduce an amount of data that may be deanonymized from leaving the device 200.

In some cases, the anonymity layer 202 may be part of, or incorporated into an operating system 206 of the device 200. The operating system 206 may be a software layer that manages hardware resources of the device 200 and provides basic services for the applications 204 to execute. As the anonymity layer 202 may collect information across a number of applications, the anonymity layer 202 may be implemented as a service of the operating system.

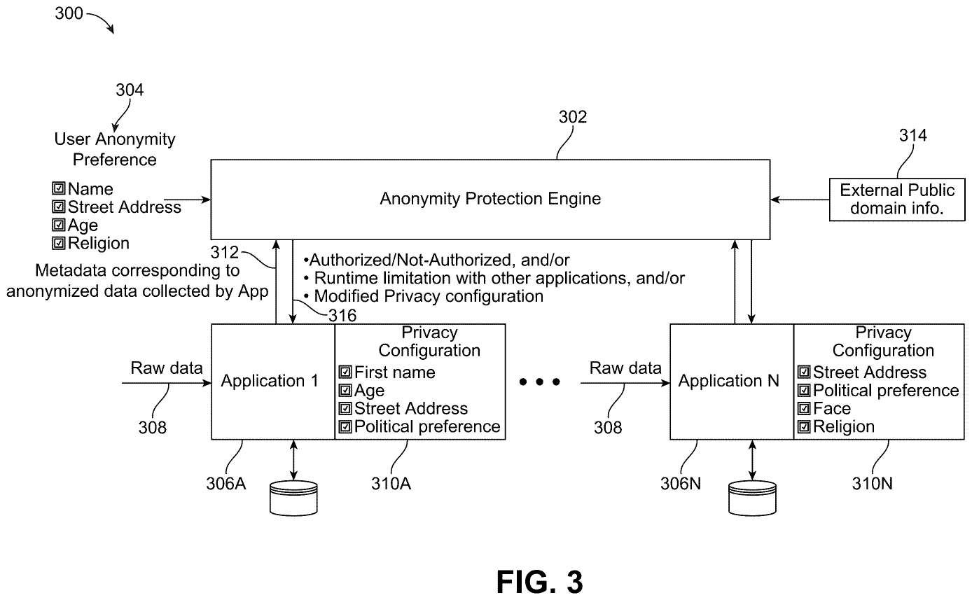

FIG. 3 is a diagram illustrating a system for on-device anonymity layer 300, in accordance with aspects of the present disclosure. As shown, the on-device anonymity layer 300 may include an anonymity protection engine (APE) 302 which may receive a set of user anonymity preferences 304 for user data obtained and/or generated by a device for a user of the device. In some cases, user anonymity preferences of the set of user anonymity preferences 304 for user data may be obtained via, for example, user input received by a user interface. In some cases, the user anonymity preferences may include attribute and preference pairs indicating whether a particular attribute (e.g., category of potentially private information) should be kept anonymous. For example, a preference may indicate that an attribute, such as a first name, may not need to be kept anonymous, while another preference may indicate that another attribute, such as age, should be kept anonymous. In some cases, a set of attributes may be defined, for example, in a standard, based on possible categories of private data, etc. Table 1, below, illustrates a portion of a set of user anonymity preferences for user data.

TABLE 1

| Attribute | Anonymity Preference |
|---|---|
| First Name | No |
| Full Name | Yes |
| Location | Yes |
| Age | Yes |
| Gender | Yes |
| . . . | . . . |

In some cases, there may be a substantial number of attribute and preference pairs, and subsets of the attribute and preference pairs may be grouped into different anonymity levels and/or types of users (e.g., child, adult, privacy concerned individual, etc.). In some cases, a device may include multiple user profiles and the set of user anonymity preferences for user data may include data gathered across users.

In some cases, each application 306A, . . . 306N, collectively applications 306, may collect and/or generate anonymized data based on raw data 308 that may be input to the applications. In some cases, the applications 306 may not include those applications that do not collect/generate user data. The applications 306 may have a privacy configuration 310A, . . . 310N (collectively privacy configuration 310). In some cases, the privacy configuration 310 of an application may indicate actions taken by the application to preserve privacy/anonymity of the user. For example, the privacy configuration 310 of an application 306A may indicate, for example, attributes collected and/or generated by the application 306A along how the application 306A may protect the attribute (e.g., left as raw data (e.g., no particular protection applied), data substitution, scrambling, rounded, blurred, etc.).

In some cases, based on the privacy configuration 310, the applications 306 may generate anonymization information indicating how user data may be collected/generated by an application, along with information about the user data, and/or how user data is protected. In some cases, the anonymization information may be organized as privacy metadata. The privacy metadata may be a standardized data structure describing the anonymization information. In some cases, the anonymization information may indicate how the user data is protected, whether the user data is anonymized, and if so, how the anonymization is performed. As an example of the privacy metadata, the privacy metadata may be in a standard format, such as (Data element name, Format, Quality). In some cases, the data element name may correspond to an attribute from a defined set of attributes, the format may indicate a data format for the user data (e.g., alphanumeric, integer, image format, etc.), and the quality may indicate how the user data is processed to protect privacy and/or anonymized (if at all). Examples of privacy metadata may include (“First name”, Alphanumeric, “Raw”), (“Age”, 10*Integer, “Rounded to nearest 10”), (“Image”, 640x420px RGB, “Faces blurred”), etc. In some cases, the privacy metadata may include additional information about how the user data is obtained, such as how often the data is collected, whether the data is time-series data, etc.

The applications 306 may transmit 312 the privacy metadata to the APE 302 and the APE 302 may receive the privacy metadata from the applications 306. In some cases, the APE 302 may also receive information about one or more sources of public information 314. In some cases, the information about one or more sources of public information 314 may be information about publicly available data, such as a description of what data is publicly available, a link to the publicly available data, and/or the publicly available data itself. In some cases, the information about one or more sources of public information 314 may be user submitted, predefined, obtained from a database, updated set of links, etc.

In some cases, the APE 302 may cross-reference and/or correlate the information in the privacy metadata from the applications 306 along with the information about one or more sources of public information 314 (if available) to determine a risk level for data deanonymization based on the user anonymity preferences. For example, the APE 302 may determine which data collected from the applications 306 or from the sources of public information 314 that may be most likely to be correlated to deanonymize particular attributes. The particular attributes likely to be deanonymized may be compared to attributes indicated in the user anonymity preferences that should be kept anonymous to determine the risk level for data deanonymization.

In some cases, the risk level for data deanonymization may be based on a number of attributes that may be deanonymized based on an amount of shared types of information between multiple applications 306, such as shared attributes, similar attributes, types of information often included in certain data formats (e.g., photos, videos, mapping information, etc.), and the like. For example, to determine the risk level for data deanonymization, the APE 302 may look at subsets of the applications 306 executing on the device. For the subsets, the APE 302 may determine an amount of shared types of information collected/generated between applications of the subset using the privacy metadata received from the applications. For example, the APE 302 may compare the attributes indicated in the privacy metadata received from the applications to determine whether there are matching attributes, or for attributes that are known to be capable of being cross-referenced/correlated (e.g., images of the environment and location data, location data and a home address, etc.). The APE 302 may determine the risk level of data deanonymization based on the attributes of the shared types of information. For instance, if an amount of (e.g., number) of shared types of information is above a threshold amount, then the APE 302 may determine that there is a high risk level of data deanonymization. The APE 302 may also present an indication of which user data (e.g., user data being collected/generated across applications resulting in shared types of information) that are at risk of data deanonymization and/or the shared types of information that caused the determination that there is a high risk level for data deanonymization. In some cases, if the amount of (e.g., number) of shared types of information is below the threshold amount, the APE 302 may determine that there is a low risk level for data deanonymization.

Based on the data deanonymization risk level, the APE 302 may use one or more strategies for preserving user anonymity. In a first strategy (e.g., static strategy), the APE 302 may determine settings of the privacy configurations 310 of the applications 306 that may be adjusted to reduce the data deanonymization risk level. For example, if an application is not anonymizing user data that the user anonymity preferences 304 indicates should be anonymous, the APE 302 may indicate 316 to an application 306 that the privacy configuration 310 of the application 306 should be adjusted. In some cases, the APE 302 may be used to directly configure settings of the privacy configuration 310 of the applications 306 based on the user anonymity preferences 304 in place of, or in conjunction with, user adjustable, per-application based settings of the privacy configuration 310.

As another example, if a first application is collecting anonymized location data, while another application is collecting images of environment which may be cross-referenced/correlated to deanonymize the anonymized location data, the APE 302 may determine that the collection of the anonymized location data may be deauthorized (e.g., stopped) to help preserve anonymity of location data for the user. In such cases, the APE 302 may indicate 316 one or more of the application 306 to stop collecting/generating user data that may be deanonymized.

In some cases, static strategies such as adjusting privacy/anonymity settings of applications 306 and/or authorizing/deauthorizing generation/collection of data may be too limiting as such strategies may just apply to applications 306 that collect/generate data concurrently.

Another strategy for preserving user anonymity (e.g., dynamic strategy) may adjust when different applications 306 may collect/generate anonymized data such that the applications 306 may collect/generate anonymized data at different times (e.g., different time windows), making cross-referencing the anonymized data and/or finding correlations between the anonymized data difficult. For example, the APE 302 may adjust when the different applications 306 are executed so that the applications 306 are not executed (e.g., prohibited from being executed) concurrently. The APE 302 may indicate 316 to the applications 306 when the applications 306 may execute (e.g., schedule the applications) to ensure that the applications that collect/generate anonymized data that may be cross-referenced and/or correlated execute at different times.

In some cases, avoiding concurrent execution of different applications 306 may be insufficient to avoid cross-referencing and deanonymizing if the anonymized data does not vary between the applications. For example, for a device, if a first application collecting anonymized location data is stopped and a second application, which also collects anonymized location data, is started immediately afterwards, it may be possible to deanonymize the location of the device based on the location when the first application is stopped and the location when the second application is started as the location of the device is the same. In some cases, APE 302 may dynamically adjust when a second application collecting data similar to, or that may be used to deanonymize data from a first application is executed based on an execution history of the first application and/or state of the device. For example, if the APE 302 determines that a first application collects/generates similar data, such as location data, as a second application, the APE 302 may delay starting the second application after the first application was stopped until a certain minimum amount of time has elapsed, or if the location of the device has changed a minimum amount (e.g., five blocks, 200 meters, etc.) between when the first application was stopped and when the second application is to be started.

In some cases, another strategy for preserving user anonymity may include adjusting the quality of anonymization that may be applied to user data collected/generated by an application to avoid data deanonymization. For example, one application may be collecting/generating user data that may be used to help deanonymize user data collected/generated by a second application. In such cases, adjusting how the data is anonymized may be useful to avoid data deanonymization. As a more specific example, data, such as an image may be collected by a first application and the first application may apply blurring to faces to anonymize the image data. However, the first application may not intend to collect license plate data. However, this license plate data may be incidentally collected by the first application and may be used to deanonymize other attributes, such as a home address, name, etc. In such cases, the APE 302 may indicate to the first application to adjust the quality of the anonymization, for example, to blur license plates or reduce image quality (e.g., resolution) to avoid being able to collect license plate information, etc. In some cases, the APE 302 may apply the adjusted anonymizations. For example, where an application does not support the adjusted anonymization, such as blurring license plates, the application may pass the collected user data to the APE 302, and the APE 302 may apply the adjusted anonymization and pass adjusted anonymization user data back to the application.

In some cases, information from the privacy metadata from the applications 306 alone may not be sufficient to evaluate the deanonymization risk level. For example, the information in the privacy metadata may not adequately describe all of the information that may be inferred from the collected/generated data. In particular, information may be inferred from collected/generated user data from an application that is not indicated in the privacy metadata as the application does not use (and may not be aware that) the inferred information. For example, image data anonymized for faces, license plates, and buildings collected by a first application may be used to deanonymize location data based on, for example, weather conditions, dates, times of day in the image data, none of which may be used by the first application. In such cases, the APE 302 may attempt to determine the risk level of data deanonymization directly from the user data collected/generated by the application, rather than, or in addition to, the privacy metadata. For example, an application 306A may transmit user data instead of, or along with, the privacy metadata for processing by the APE 302.

In some cases, the APE 302 may receive either a statistically representative sample or a random sample of the user data collected/generated by the application 306A and the APE 302 may process the sample to determine whether the sample includes elements that may be used to infer information that may be used to deanonymize attributes that should be anonymized (e.g., based on the anonymity preferences). If the sample includes elements that may be used to infer information that may be used to deanonymize attributes (e.g., that there is a high risk level of data deanonymization), then the APE 302 may initiate directly processing the user data from the application. If the sample does not include elements that may be used to infer information that may be used to deanonymize attributes (e.g., that there is a low risk level of data deanonymization), then the APE 302 may indicate that there is no need to directly process the user data from the application.

In some cases, directly processing the user data from the application may result in increased robustness against deanonymization as the APE 302 may have more information about what exactly is in the user data. In some cases, directly processing the user data by the APE 302 may incur higher processing costs and higher communication costs for transmitting the user data. In some cases, the APE 302 may directly process certain types of user data, such as those data types that are more likely to include inferable data (e.g., PII, channel state information, etc.), and the APE 302 may use information from the privacy metadata for those data types that are less likely to include inferable data (e.g., extracted features from images/sensor data/location data, etc.).

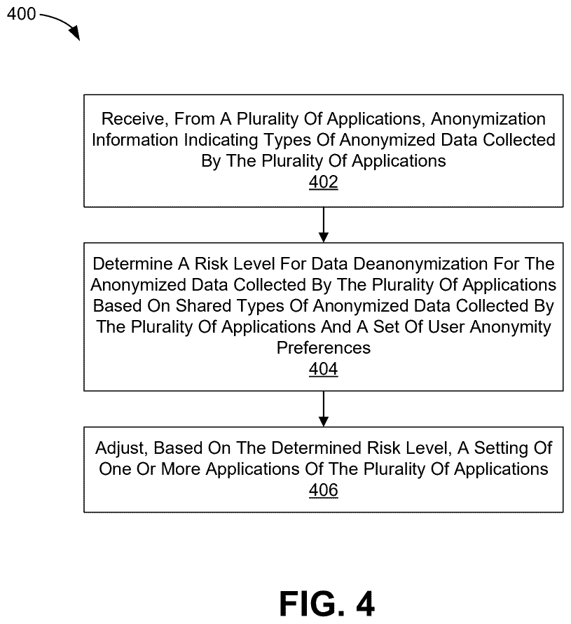

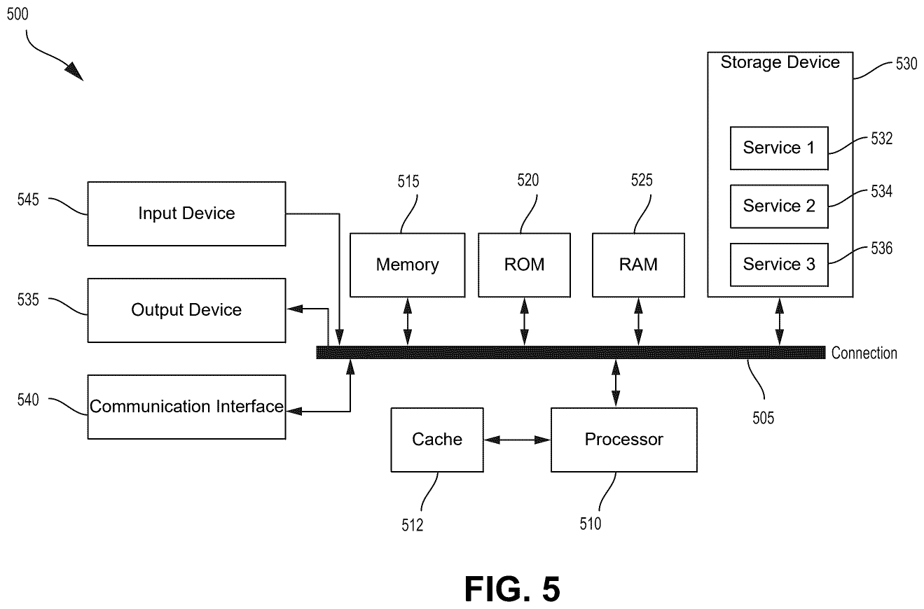

FIG. 4 is a flow diagram illustrating a process 400 for data privacy, in accordance with aspects of the present disclosure. The process 400 may be performed by a computing device (or apparatus) (e.g., SOC 100 of FIG. 1, device 200 of FIG. 2, computing device architecture 500 of FIG. 5) or a component (e.g., a chipset, codec, CPU 102, GPU 104, DSP 106, NPU 108 of FIG. 1, processor 510 of FIG. 5, etc.) of the computing device. The computing device may be a mobile device (e.g., a mobile phone), a network-connected wearable such as a watch, an extended reality (XR) device such as a virtual reality (VR) device or augmented reality (AR) device, a vehicle or component or system of a vehicle, or other type of computing device. The operations of the process 400 may be implemented as software components (e.g., anonymity protection engine 202 of FIG. 2, anonymity protection engine 302 of FIG. 3, etc.) that are executed and run on one or more processors.

At block 402, the computing device (or component thereof) may receive, from a plurality of applications (e.g., applications 204 of FIG. 2, applications 306 of FIG. 3, etc.), anonymization information indicating types of anonymized data collected by the plurality of applications. For example, the anonymity protection engine may receive the privacy metadata from the applications. In some cases, the computing device (or component thereof) may obtain public information about a user though one or more sources of public information (e.g., one or more sources of public information 314 of FIG. 3) and determine the risk level for data deanonymization based on the obtained public information. In some examples, the anonymization information includes privacy metadata and an expected amount of anonymity. In some cases, the anonymization information includes at least one of an attribute, a data format associated with the attribute, or how user data was processed to anonymize the user data. In some examples, the anonymization information includes how the user data was processed to anonymize the user data. In some cases, the computing device (or component thereof) may adjust the setting of the plurality of applications by adjusting how the user data is processed to anonymize the user data. In some examples, the anonymization information includes how the user data was processed to anonymize the user data. In some cases, the computing device (or component thereof) may receive user data collected by a first application and determine a risk level for data deanonymization based on the user data received from the first application.

At block 404, the computing device (or component thereof) may determine a risk level for data deanonymization for the anonymized data collected by the plurality of applications based on shared types of data collected by the plurality of applications. For example, the anonymity protection engine may cross-reference and/or correlate the information in the privacy metadata from the applications to determine a risk level for data deanonymization based on the user anonymity preferences. In some cases, the anonymity protection engine may determine which data collected from the applications may be most likely to be correlated to deanonymize particular attributes.

At block 406, the computing device (or component thereof) may adjust, based on the determined risk level, a setting of an application of the plurality of applications. In some cases, the computing device (or component thereof) may adjust the setting of the plurality of applications to prohibit execution of a first application concurrently with a second application. In some examples, the computing device (or component thereof) may adjust the setting of the plurality of applications by adjusting privacy configurations (e.g., privacy configurations 310 of FIG. 3) of an application of the plurality of applications. In some cases, the computing device (or component thereof) may adjust the setting of the plurality of applications to prohibit execution of a first application based on a history of execution for a second application. In some examples, execution of the first application after the second application has been stopped is prohibited until a minimum amount of time has elapsed. In some cases, the computing device (or component thereof) may adjust the setting of the plurality of applications by indicating a change to a data element of the anonymization information associated with an application. In some examples, the computing device (or component thereof) may determine the risk level for data deanonymization based on a set of user anonymity preferences (e.g., user anonymity preferences 304 of FIG. 3) and adjust the setting of the plurality of applications based on the set of user anonymity preferences.

In some examples, the techniques or processes described herein may be performed by a computing device, an apparatus, and/or any other computing device. In some cases, the computing device or apparatus may include a processor, microprocessor, microcomputer, or other component of a device that is configured to carry out the steps of processes described herein. In some examples, the computing device or apparatus may include a camera configured to capture video data (e.g., a video sequence) including video frames. For example, the computing device may include a camera device, which may or may not include a video codec. As another example, the computing device may include a mobile device with a camera (e.g., a camera device such as a digital camera, an IP camera or the like, a mobile phone or tablet including a camera, or other type of device with a camera). In some cases, the computing device may include a display for displaying images. In some examples, a camera or other capture device that captures the video data is separate from the computing device, in which case the computing device receives the captured video data. The computing device may further include a network interface, transceiver, and/or transmitter configured to communicate the video data. The network interface, transceiver, and/or transmitter may be configured to communicate Internet Protocol (IP) based data or other network data.

The processes described herein can be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement the processes.

In some cases, the devices or apparatuses configured to perform the operations of the process 400 and/or other processes described herein may include a processor, microprocessor, micro-computer, or other component of a device that is configured to carry out the steps of the process 400 and/or other process. In some examples, such devices or apparatuses may include one or more sensors configured to capture image data and/or other sensor measurements. In some examples, such computing device or apparatus may include one or more sensors and/or a camera configured to capture one or more images or videos. In some cases, such device or apparatus may include a display for displaying images. In some examples, the one or more sensors and/or camera are separate from the device or apparatus, in which case the device or apparatus receives the sensed data. Such device or apparatus may further include a network interface configured to communicate data.

The components of the device or apparatus configured to carry out one or more operations of the process 400 and/or other processes described herein can be implemented in circuitry. For example, the components can include and/or can be implemented using electronic circuits or other electronic hardware, which can include one or more programmable electronic circuits (e.g., microprocessors, graphics processing units (GPUs), digital signal processors (DSPs), central processing units (CPUs), and/or other suitable electronic circuits), and/or can include and/or be implemented using computer software, firmware, or any combination thereof, to perform the various operations described herein. The computing device may further include a display (as an example of the output device or in addition to the output device), a network interface configured to communicate and/or receive the data, any combination thereof, and/or other component(s). The network interface may be configured to communicate and/or receive Internet Protocol (IP) based data or other type of data.

The process 400 is illustrated as a logical flow diagram, the operations of which represent sequences of operations that can be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement the processes.

Additionally, the processes described herein (e.g., the process 400 and/or other processes) may be performed under the control of one or more computer systems configured with executable instructions and may be implemented as code (e.g., executable instructions, one or more computer programs, or one or more applications) executing collectively on one or more processors, by hardware, or combinations thereof. As noted above, the code may be stored on a computer-readable or machine-readable storage medium, for example, in the form of a computer program including a plurality of instructions executable by one or more processors. The computer-readable or machine-readable storage medium may be non-transitory.

Additionally, the processes described herein may be performed under the control of one or more computer systems configured with executable instructions and may be implemented as code (e.g., executable instructions, one or more computer programs, or one or more applications) executing collectively on one or more processors, by hardware, or combinations thereof. As noted above, the code may be stored on a computer-readable or machine-readable storage medium, for example, in the form of a computer program comprising a plurality of instructions executable by one or more processors. The computer-readable or machine-readable storage medium may be non-transitory.

FIG. 5 illustrates an example computing device architecture 500 of an example computing device which can implement the various techniques described herein. In some examples, the computing device can include a mobile device, a wearable device, an extended reality device (e.g., a virtual reality (VR) device, an augmented reality (AR) device, or a mixed reality (MR) device), a personal computer, a laptop computer, a video server, a vehicle (or computing device of a vehicle), or other device. The components of computing device architecture 500 are shown in electrical communication with each other using connection 505, such as a bus. The example computing device architecture 500 includes a processing unit (CPU or processor) 510 and computing device connection 505 that couples various computing device components including computing device memory 515, such as read only memory (ROM) 520 and random access memory (RAM) 525, to processor 510.

Computing device architecture 500 can include a cache of high-speed memory connected directly with, in close proximity to, or integrated as part of processor 510. Computing device architecture 500 can copy data from memory 515 and/or the storage device 530 to cache 512 for quick access by processor 510. In this way, the cache can provide a performance boost that avoids processor 510 delays while waiting for data. These and other modules can control or be configured to control processor 510 to perform various actions. Other computing device memory 515 may be available for use as well. Memory 515 can include multiple different types of memory with different performance characteristics. Processor 510 can include any general purpose processor and a hardware or software service, such as service 1 532, service 2 534, and service 3 536 stored in storage device 530, configured to control processor 510 as well as a special-purpose processor where software instructions are incorporated into the processor design. Processor 510 may be a self-contained system, containing multiple cores or processors, a bus, memory controller, cache, etc. A multi-core processor may be symmetric or asymmetric.

To enable user interaction with the computing device architecture 500, input device 545 can represent any number of input mechanisms, such as a microphone for speech, a touch-sensitive screen for gesture or graphical input, keyboard, mouse, motion input, speech and so forth. Output device 535 can also be one or more of a number of output mechanisms known to those of skill in the art, such as a display, projector, television, speaker device, etc. In some instances, multimodal computing devices can enable a user to provide multiple types of input to communicate with computing device architecture 500. Communication interface 540 can generally govern and manage the user input and computing device output. There is no restriction on operating on any particular hardware arrangement and therefore the basic features here may easily be substituted for improved hardware or firmware arrangements as they are developed.

Storage device 530 is a non-volatile memory and can be a hard disk or other types of computer readable media which can store data that are accessible by a computer, such as magnetic cassettes, flash memory cards, solid state memory devices, digital versatile disks, cartridges, random access memories (RAMs) 525, read only memory (ROM) 520, and hybrids thereof. Storage device 530 can include services 532, 534, 536 for controlling processor 510. Other hardware or software modules are contemplated. Storage device 530 can be connected to the computing device connection 505. In one aspect, a hardware module that performs a particular function can include the software component stored in a computer-readable medium in connection with the necessary hardware components, such as processor 510, connection 505, output device 535, and so forth, to carry out the function.

Aspects of the present disclosure are applicable to any suitable electronic device (such as security systems, smartphones, tablets, laptop computers, vehicles, drones, or other devices) including or coupled to one or more active depth sensing systems. While described below with respect to a device having or coupled to one light projector, aspects of the present disclosure are applicable to devices having any number of light projectors, and are therefore not limited to specific devices.

The term “device” is not limited to one or a specific number of physical objects (such as one smartphone, one controller, one processing system and so on). As used herein, a device may be any electronic device with one or more parts that may implement at least some portions of this disclosure. While the below description and examples use the term “device” to describe various aspects of this disclosure, the term “device” is not limited to a specific configuration, type, or number of objects. Additionally, the term “system” is not limited to multiple components or specific embodiments. For example, a system may be implemented on one or more printed circuit boards or other substrates, and may have movable or static components. While the below description and examples use the term “system” to describe various aspects of this disclosure, the term “system” is not limited to a specific configuration, type, or number of objects.

Specific details are provided in the description above to provide a thorough understanding of the embodiments and examples provided herein. However, it will be understood by one of ordinary skill in the art that the embodiments may be practiced without these specific details. For clarity of explanation, in some instances the present technology may be presented as including individual functional blocks including functional blocks comprising devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

Individual embodiments may be described above as a process or method which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed but could have additional steps not included in a figure. A process may correspond to a method, a function, a procedure, a subroutine, a subprogram, etc. When a process corresponds to a function, its termination can correspond to a return of the function to the calling function or the main function.

Processes and methods according to the above-described examples can be implemented using computer-executable instructions that are stored or otherwise available from computer-readable media. Such instructions can include, for example, instructions and data which cause or otherwise configure a general-purpose computer, special purpose computer, or a processing device to perform a certain function or group of functions. Portions of computer resources used can be accessible over a network. The computer executable instructions may be, for example, binaries, intermediate format instructions such as assembly language, firmware, source code, etc.

The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as flash memory, memory or memory devices, magnetic or optical disks, flash memory, USB devices provided with non-volatile memory, networked storage devices, compact disk (CD) or digital versatile disk (DVD), any suitable combination thereof, among others. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc., may be passed, forwarded, or transmitted via any suitable means including memory sharing, message passing, token passing, network transmission, or the like.

In some embodiments, the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Devices implementing processes and methods according to these disclosures can include hardware, software, firmware, middleware, microcode, hardware description languages, or any combination thereof, and can take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Typical examples of form factors include laptops, smart phones, mobile phones, tablet devices or other small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are example means for providing the functions described in the disclosure.

In the foregoing description, aspects of the application are described with reference to specific embodiments thereof, but those skilled in the art will recognize that the application is not limited thereto. Thus, while illustrative embodiments of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, embodiments can be utilized in any number of environments and applications beyond those described herein without departing from the broader spirit and scope of the specification. The specification and drawings are, accordingly, to be regarded as illustrative rather than restrictive. For the purposes of illustration, methods were described in a particular order. It should be appreciated that in alternate embodiments, the methods may be performed in a different order than that described.

One of ordinary skill will appreciate that the less than (“<”) and greater than (“>”) symbols or terminology used herein can be replaced with less than or equal to (“<”) and greater than or equal to (“>”) symbols, respectively, without departing from the scope of this description.

Where components are described as being “configured to” perform certain operations, such configuration can be accomplished, for example, by designing electronic circuits or other hardware to perform the operation, by programming programmable electronic circuits (e.g., microprocessors or other suitable electronic circuits) to perform the operation, or any combination thereof.

The phrase “coupled to” refers to any component that is physically connected to another component either directly or indirectly and/or any component that is in communication with another component (e.g., connected to the other component over a wired or wireless connection, and/or other suitable communication interface) either directly or indirectly.

Claim language or other language reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, A and B and C, or any duplicate information or data (e.g., A and A, B and B, C and C, A and A and B, and so on), or any other ordering, duplication, or combination of A, B, and C. The language “at least one of” a set and/or “one or more” of a set does not limit the set to the items listed in the set. For example, claim language reciting “at least one of A and B” or “at least one of A or B” may mean A, B, or A and B, and may additionally include items not listed in the set of A and B. The phrases “at least one” and “one or more” are used interchangeably herein.

Claim language or other language reciting “at least one processor configured to,” “at least one processor being configured to,” “one or more processors configured to,” “one or more processors being configured to,” or the like indicates that one processor or multiple processors (in any combination) can perform the associated operation(s). For example, claim language reciting “at least one processor configured to: X, Y, and Z” means a single processor can be used to perform operations X, Y, and Z; or that multiple processors are each tasked with a certain subset of operations X, Y, and Z such that together the multiple processors perform X, Y, and Z; or that a group of multiple processors work together to perform operations X, Y, and Z. In another example, claim language reciting “at least one processor configured to: X, Y, and Z” can mean that any single processor may only perform at least a subset of operations X, Y, and Z.

Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions.

Where reference is made to an entity (e.g., any entity or device described herein) performing functions or being configured to perform functions (e.g., steps of a method), the entity may be configured to cause one or more elements (individually or collectively) to perform the functions. The one or more components of the entity may include at least one memory, at least one processor, at least one communication interface, another component configured to perform one or more (or all) of the functions, and/or any combination thereof. Where reference to the entity performing functions, the entity may be configured to cause one component to perform all functions, or to cause more than one component to collectively perform the functions. When the entity is configured to cause more than one component to collectively perform the functions, each function need not be performed by each of those components (e.g., different functions may be performed by different components) and/or each function need not be performed in whole by only one component (e.g., different components may perform different sub-functions of a function).

The various illustrative logical blocks, modules, circuits, and algorithm steps described in connection with the embodiments disclosed herein may be implemented as electronic hardware, computer software, firmware, or combinations thereof. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present application.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the methods described above. The computer-readable data storage medium may form part of a computer program product, which may include packaging materials. The computer-readable medium may comprise memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein.

Illustrative aspects of the disclosure include:
Aspect 1. An apparatus for data privacy, comprising: a memory; and a processor coupled to the memory and configured to: receive, from a plurality of applications, anonymization information indicating types of anonymized data collected by the plurality of applications; determine a risk level for data deanonymization for the anonymized data collected by the plurality of applications based on shared types of data collected by the plurality of applications; and adjust, based on the determined risk level, a setting of an application of the plurality of applications.
Aspect 2. The apparatus of Aspect 1, wherein the processor is further configured to: obtain public information about a user though one or more sources of public information; and determine the risk level for data deanonymization based on the obtained public information.
Aspect 3. The apparatus of any of Aspects 1-2, wherein the processor is further configured to adjust the setting of the plurality of applications to prohibit execution of a first application concurrently with a second application.
Aspect 4. The apparatus of any of Aspects 1-3, wherein the processor is further configured to adjust the setting of the plurality of applications by adjusting privacy configurations of an application of the plurality of applications.
Aspect 5. The apparatus of any of Aspects 1-4, wherein the processor is further configured to adjust the setting of the plurality of applications to prohibit execution of a first application based on a history of execution for a second application.
Aspect 6. The apparatus of Aspect 5, wherein execution of the first application after the second application has been stopped is prohibited until a minimum amount of time has elapsed.
Aspect 7. The apparatus of any of Aspects 1-6, wherein the processor is further configured to adjust the setting of the plurality of applications by indicating a change to a data element of the anonymization information associated with an application.
Aspect 8. The apparatus of any of Aspects 1-7, wherein the processor is further configured to: determine the risk level for data deanonymization based on a set of user anonymity preferences; and adjust the setting of the plurality of applications based on the set of user anonymity preferences.
Aspect 9. The apparatus of any of Aspects 1-8, wherein the anonymization information includes privacy metadata and an expected amount of anonymity, and wherein the anonymization information includes at least one of an attribute, a data format associated with the attribute, or how user data was processed to anonymize the user data.
Aspect 10. The apparatus of Aspect 9, wherein the anonymization information includes how the user data was processed to anonymize the user data, and wherein the processor is further configured to adjust the setting of the plurality of applications by adjusting how the user data is processed to anonymize the user data.
Aspect 11. The apparatus of any of Aspects 1-10, wherein the processor is further configured to: receive user data collected by a first application; and determine a risk level for data deanonymization based on the user data received from the first application.
Aspect 12. A method for data privacy, comprising: receiving, from a plurality of applications, anonymization information indicating types of anonymized data collected by the plurality of applications; determining a risk level for data deanonymization for the anonymized data collected by the plurality of applications based on shared types of data collected by the plurality of applications; and adjusting, based on the determined risk level, a setting of an application of the plurality of applications.
Aspect 13. The method of Aspect 12, further comprising obtaining public information about a user though one or more sources of public information, and wherein determining the risk level for data deanonymization is further based on the obtained public information.
Aspect 14. The method of any of Aspects 12-13, wherein adjusting the setting of the plurality of applications comprises prohibiting execution of a first application concurrently with a second application.
Aspect 15. The method of any of Aspects 12-14, wherein adjusting the setting of the plurality of applications comprises adjusting privacy configurations of an application of the plurality of applications.
Aspect 16. The method of any of Aspects 12-15, wherein adjusting the setting of the plurality of applications comprises prohibiting execution of a first application based on a history of execution for a second application.
Aspect 17. The method of Aspect 16, wherein execution of the first application after the second application has been stopped is prohibited until a minimum amount of time has elapsed.
Aspect 18. The method of any of Aspects 12-17, wherein adjusting the setting of the plurality of applications comprises indicating a change to a data element of the anonymization information associated with an application.
Aspect 19. The method of any of Aspects 12-18, wherein the risk level for data deanonymization is further determined based on a set of user anonymity preferences, and further comprising adjusting the setting of the plurality of applications based on the set of user anonymity preferences.
Aspect 20. The method of any of Aspects 12-19, wherein the anonymization information includes privacy metadata and an expected amount of anonymity, and wherein the anonymization information includes at least one of an attribute, a data format associated with the attribute, or how user data was processed to anonymize the user data.
Aspect 21. The method of Aspect 20, wherein the anonymization information includes how the user data was processed to anonymize the user data, and wherein adjusting the setting of the plurality of applications comprises adjusting how the user data is processed to anonymize the user data.
Aspect 22. The method of any of Aspects 12-21, further comprising: receiving user data collected by a first application; and determining a risk level for data deanonymization based on the user data received from the first application.
Aspect 23. A non-transitory computer-readable medium having stored thereon instructions that, when executed by at least one processor, cause the at least one processor to perform operations according to any one or more of Aspects 12-22.
Aspect 24: An apparatus comprising one or more means for performing operations according to any one or more of Aspects 12-22.

What is claimed is:

1. An apparatus for data privacy, comprising:
a memory; and
a processor coupled to the memory and configured to:
receive, from a plurality of applications, anonymization information indicating types of anonymized data collected by the plurality of applications;
determine a risk level for data deanonymization for the anonymized data collected by the plurality of applications based on shared types of data collected by the plurality of applications; and
adjust, based on the determined risk level, a setting of an application of the plurality of applications.

2. The apparatus of claim 1, wherein the processor is further configured to:
obtain public information about a user though one or more sources of public information; and
determine the risk level for data deanonymization based on the obtained public information.

3. The apparatus of claim 1, wherein the processor is further configured to adjust the setting of the plurality of applications to prohibit execution of a first application concurrently with a second application.

4. The apparatus of claim 1, wherein the processor is further configured to adjust the setting of the plurality of applications by adjusting privacy configurations of an application of the plurality of applications.

5. The apparatus of claim 1, wherein the processor is further configured to adjust the setting of the plurality of applications to prohibit execution of a first application based on a history of execution for a second application.

6. The apparatus of claim 5, wherein execution of the first application after the second application has been stopped is prohibited until a minimum amount of time has elapsed.

7. The apparatus of claim 1, wherein the processor is further configured to adjust the setting of the plurality of applications by indicating a change to a data element of the anonymization information associated with an application.

8. The apparatus of claim 1, wherein the processor is further configured to:
determine the risk level for data deanonymization based on a set of user anonymity preferences; and
adjust the setting of the plurality of applications based on the set of user anonymity preferences.

9. The apparatus of claim 1, wherein the anonymization information includes privacy metadata and an expected amount of anonymity, and wherein the anonymization information includes at least one of an attribute, a data format associated with the attribute, or how user data was processed to anonymize the user data.

10. The apparatus of claim 9, wherein the anonymization information includes how the user data was processed to anonymize the user data, and wherein the processor is further configured to adjust the setting of the plurality of applications by adjusting how the user data is processed to anonymize the user data.

11. The apparatus of claim 1, wherein the processor is further configured to:
receive user data collected by a first application; and
determine a risk level for data deanonymization based on the user data received from the first application.

12. A method for data privacy, comprising:
receiving, from a plurality of applications, anonymization information indicating types of anonymized data collected by the plurality of applications;
determining a risk level for data deanonymization for the anonymized data collected by the plurality of applications based on shared types of data collected by the plurality of applications; and
adjusting, based on the determined risk level, a setting of an application of the plurality of applications.

13. The method of claim 12, further comprising obtaining public information about a user though one or more sources of public information, and wherein determining the risk level for data deanonymization is further based on the obtained public information.

14. The method of claim 12, wherein adjusting the setting of the plurality of applications comprises prohibiting execution of a first application concurrently with a second application.

15. The method of claim 12, wherein adjusting the setting of the plurality of applications comprises adjusting privacy configurations of an application of the plurality of applications.

16. The method of claim 12, wherein adjusting the setting of the plurality of applications comprises prohibiting execution of a first application based on a history of execution for a second application.

17. The method of claim 12, wherein adjusting the setting of the plurality of applications comprises indicating a change to a data element of the anonymization information associated with an application.

18. The method of claim 12, wherein the risk level for data deanonymization is further determined based on a set of user anonymity preferences, and further comprising adjusting the setting of the plurality of applications based on the set of user anonymity preferences.

19. The method of claim 12, wherein the anonymization information includes privacy metadata and an expected amount of anonymity, and wherein the anonymization information includes at least one of an attribute, a data format associated with the attribute, or how user data was processed to anonymize the user data.

20. The method of claim 12, further comprising:
receiving user data collected by a first application; and
determining a risk level for data deanonymization based on the user data received from the first application.
